(19) United States
(12) Patent Application Publication
(10) Pub. No.: US 2012/0070771 A1
(43) Pub. Date: Mar. 22, 2012

(54) ELECTROPHOTOGRAPHIC TONER

(75) Inventors: Satoshi Araki, Shizuoka-ken (JP); Junichi Ishikawa, Shizuoka-ken (JP)

(73) Assignee: TOSHIBA TEC KABUSHIKI KAISHA, Tokyo (JP)

(21) Appl. No.: 13/222,117

(22) Filed: Aug. 31, 2011

Related U.S. Application Data
(60) Provisional application No. 61/384,078, filed on Sep. 17, 2010.

(51) Int. Cl. G03G 9/08

(52) U.S. Cl. 430/108.3

(57) ABSTRACT

Disclosed is an electrophotographic toner, comprising: toner base particles having a volume average particle diameter of 3 μm or more and 7 μm or less; OTES-treated silica particles which are treated with octyltriethoxysilane (OTES) and are externally added to the toner base particles; and silica-coated titanium oxide particles which are coated with silica and are externally added to the toner base particles along with the OTES-treated silica particles, wherein the ratio (A) of the amount of the OTES-treated silica particles to the amount of the toner base particles, the ratio (B) of the amount of the silica-coated titanium oxide particles to the amount of the toner base particles, and the ratio (C) of the amount of particles to be externally added to the toner base particles to the amount of the toner base particles satisfy the following relations: 1% by mass≦(A)≦6.9% by mass; 0.1% by mass≦(B)≦2% by mass; 3% by mass≦(C)≦7% by mass; and 0.15≦(A)/(C)<1.

### CROSS-REFERENCE TO RELATED APPLICATION

This application is also based upon and claims the benefit of priority from U.S. provisional application 61/384,078, filed on Sep. 17, 2010; the entire contents of which are incorporated herein by reference.

### FIELD

Embodiments described herein relate to a technique for an electrophotographic toner.

### BACKGROUND

Recently, in order to achieve high image quality, the particle diameter of a toner is decreased, and a toner having a particle diameter of from about 4 to 7 μm is becoming mainstream. However, if the particle diameter of a toner is decreased, the number of particles per unit weight is increased, and therefore, a charge amount (q/m) is increased to deteriorate the developing property. Meanwhile, if a charge amount (q/m) is decreased, an average charge amount (q/d) is also decreased, and therefore, there is a problem that toner scattering is caused.

In addition, if a toner has a small particle diameter, it is necessary to increase an external additive in order to maintain a covering ratio. However, if an external addition treatment is performed in the same manner as a conventional treatment, the attachment force of an external additive to a toner is low, and therefore the external additive is detached and there is a problem that a decrease in the charge amount is caused with the passing of time.

In order to solve this problem, generally, the charging property is optimized by using a silicon oxide (silica) and titanium oxide in combination as an external additive. However, further improvement of the charging property is demanded.

### DESCRIPTION OF THE DRAWINGS

FIG. 1 is a graph showing relations among (A), (B), and (C) according to an embodiment for facilitating the understanding of the relations.

FIG. 2 is a table showing the structures and properties of toners of Examples and Comparative examples.

### DETAILED DESCRIPTION

The toner according to an embodiment is an electrophotographic toner including toner base particles having a volume average particle diameter of 3 μm or more and 7 μm or less; OTES-treated silica particles which are silica particles treated with octyltriethoxysilane (OTES) and are externally added to the toner base particles; and silica-coated titanium oxide particles which are titanium oxide particles coated with silica and are externally added to the toner base particles along with the OTES-treated silica particles. The toner according to this embodiment is configured such that the ratio (A) of the amount of the OTES-treated silica particles to the amount of the toner base particles, the ratio (B) of the amount of the silica-coated titanium oxide particles to the amount of the toner base particles, and the ratio (C) of the amount of particles to be externally added to the toner base particles to the amount of the toner base particles satisfy the following relations:

1% by mass≦(A)≦6.9% by mass;

0.1% by mass≦(B)≦2% by mass;

3% by mass≦(C)≦7% by mass; and

0.15≦(A)/(C)<1.

Hereinafter, embodiments will be described with reference to the drawings.

Silica particles used as an external additive for improving a charging property are useful as an agent for controlling a charge amount, however, the attachment force thereof to a toner is lower than other external additives, and therefore, the silica particles contaminate a developer to decrease the charge amount in some cases. Further, titanium oxide particles to be used in combination with silica particles have a function to make the rise-up of charge favorable and also to make the charge amount distribution sharp thereby to suppress toner scattering. However, the hydrophilicity of the surfaces of the titanium oxide particles is higher than that of a silicon-based external additive, and therefore, the titanium oxide particles are liable to absorb moisture, and therefore, an environmental variation in the charge amount of a toner is increased and image fogging or the like is caused in some cases.

The present inventors found, as a result of intensive studies, that in a toner including toner base particles having a volume average particle diameter of 3 μm or more and 7 μm or less, by externally adding silica particles treated with OTES and titanium oxide particles having surfaces coated with silica to the toner base particles, a decrease in the charge amount with the passing of time and an environmental variation in the charge amount can be suppressed. By using the silica particles treated with OTES as an external additive, the detachment of the external additive from the toner can be suppressed. In addition, by using the titanium oxide particles having surfaces coated with silica as an external additive along with the silica particles treated with OTES, the hydrophilicity of the surfaces thereof becomes comparable to that of the silicon oxide-based external additive, and the rise-up of charge and the charge amount distribution are made sharp without increasing the environmental variation, and therefore, toner scattering can be suppressed.

Incidentally, the silica particle treated with OTES refers to a silica particle having a surface modified (hydrophobized) by a reaction with OTES (hereinafter also referred to as an OTES-treated silica particle).

In this embodiment, the amount of the silica particles to be treated with OTES is not particularly limited and can be appropriately set by those skilled in the art. However, for example, the amount of untreated silica particles can be set to less than about 50 μmol/m².

Further, the particle diameter of the OTES-treated silica particles is not particularly limited and can be appropriately set by those skilled in the art. However, the particle diameter thereof can be set to, for example, 20 to 85 nm when determined by a dynamic light scattering method.

As the OTES-treated silica particles, a commercially available product may be used, and for example, TGC-443 manufactured by Cabot Corporation can be used.

Further, as for the silica-coated titanium oxide particles, the ratio of the surface of the particle coated with silica is not particularly limited and can be appropriately set by those skilled in the art. However, for example, the ratio thereof can be set to 5 to 30% by mass of the amount of the silica-coated titanium oxide particles.

Further, the particle diameter of the silica-coated titanium oxide particles is not particularly limited and can be appropriately set by those skilled in the art. However, for example, the particle diameter thereof can be set to 10 to 50 nm when determined by a dynamic light scattering method.

Also as the silica-coated titanium oxide particles, a commercially available product can be used, and for example, STX-801 or STX-501 manufactured by Aerosil Co., Ltd. can be used.

The particle diameters of the OTES-treated silica particles and the silica-coated titanium oxide particles are not particularly limited and can be appropriately set by those skilled in the art.

Incidentally, the external addition refers to a treatment in which particles to be used as an external additive are attached or adhered to the surfaces of the toner base particles.

Further, the toner base particle contains a binder resin and a coloring agent, and refers to a toner particle from which an external additive is removed or refers to a toner particle before adding an external additive.

The volume average particle diameter refers to the particle diameter (volume D50) of a particle the value of which is arrived at when the cumulative volume distribution of the particles reaches 50% determined from the sum of the volumes of the individual particles calculated from the particle diameters. The volume average particle diameter can be determined using, for example, Multisizer 3 (aperture diameter: 100 μm, manufactured by Beckman Coulter, Inc.). The volume average particle diameter can be obtained by measuring the diameters of, for example, 50000 particles.

In this embodiment, the ratio (A) of the amount of the OTES-treated silica particles to the amount of the toner base particles and the ratio (B) of the amount of the silica-coated titanium oxide particles to the amount of the toner base particles satisfy the following relations (1) and (2).

1% by mass≦(A)≦6.9% by mass (1)

0.1% by mass≦(B)≦2% by mass (2)

If (A) is less than 1% by mass, the amount of the external additive is not sufficient, and therefore, the fluidity is deteriorated. As a result, the conveying performance of the toner in an actual apparatus is deteriorated as compared with the case where (A) is within the above range. Further, the detachment of an external additive other than the OTES-treated silica particles becomes prominent, and the charge amount is liable to decrease with the passing of time as compared with the case where (A) is within the above range. Meanwhile, if (A) is more than 6.9% by mass, the amount of the external additive is too much, and therefore, the OTES-treated silica particles are easily detached and the charge amount is liable to decrease with the passing of time as compared with the case where (A) is within the above range.

If (B) is less than 0.1% by mass, toner scattering becomes prominent as compared with the case where (B) is within the above range. Meanwhile if (B) is more than 2% by mass, the silica-coated titanium oxide particles are easily detached and the charge amount is liable to decrease with the passing of time as compared with the case where (B) is within the above range.

Further, in the toner according to this embodiment, in addition to the relations (1) and (2), the toner satisfies the following relations (3) and (4) when the ratio of the amount of particles to be externally added to the toner base particles (the total amount of the external additive) to the amount of the toner base particles is represented by (C).

3% by mass≦(C)≦7% by mass (3)

0.15≦(A)/(C)<1 (4)

If (C) is less than 3% by mass, the amount of the external additive is not sufficient, and therefore, the fluidity is deteriorated in some cases as compared with the case where (C) is within the above range. Meanwhile, if (C) is more than 7% by mass, the amount of the external additive is too much, and therefore, the external additive is easily detached and the charge amount is liable to decrease with the passing of time as compared with the case where (C) is within the above range.

If (A)/(C) is less than 0.15, the detachment of the external additive other than the OTES-treated silica particles becomes prominent, and the charge amount is liable to decrease with the passing of time as compared with the case where (A)/(C) is within the above range.

Incidentally, if (A)/(C) is 0.5 or more, toner scattering and a decrease in the charge amount with the passing of time can be further suppressed, and therefore the toner satisfying the relation: (A)/(C)≧0.5 is more preferred.

In this embodiment, also particles other than the OTES-treated silica particles and silica-coated titanium oxide particles may be externally added to the toner. The particles to be used as an external additive are not particularly limited other than the OTES-treated silica particles and the silica-coated titanium oxide particles and can be appropriately selected by those skilled in the art. Examples thereof include silica particles treated with dimethyldichlorosilane (DDS), silica particles treated with hexamethyldisilazane (HMDS), silica particles treated with polydimethylsiloxane (PDMS), and titanium oxide particles treated with alkylsilane (RS) (NKT-90 and T-805, manufactured by Aerosil Co., Ltd.).

Examples of the silica particles treated with DDS include R-972, R-974, R976S, and R-9200, all of which are manufactured by Aerosil Co., Ltd. Further, examples of the silica particles treated with HMDS include RX-50, NAX-50, NX-90G, RX-200, R-8200, RX-300, R812S, and R-812, all of which are manufactured by Aerosil Co., Ltd., TG-6110G, TG-810G, and TG-811F, all of which are manufactured by Cabot Corporation, H2000/4, H2000T, H05TM, H13TM, H20TM, and H30TM, all of which are manufactured by Clariant Co., Ltd., and X-24-9163A manufactured by Shin-Etsu Chemical Co., Ltd. Examples of the silica particles treated with PDMS include RY-50, NY-50, RY-200S, RY-200, RY-200L, and RY-300, all of which are manufactured by Aerosil Co., Ltd., TG-308F and TG-7580F, both of which are manufactured by Cabot Corporation, and H05TD, H13TD, H20TD, and H30TD, all of which are manufactured by Clariant Co., Ltd. Examples of the titanium oxide particles treated with RS include NKT-90 and T-805, both of which are manufactured by Aerosil Co., Ltd.

In addition, particles surface-treated with two or more treatment agents selected from the above-described DDS, PDMS, and RS can also be used as an external agent.

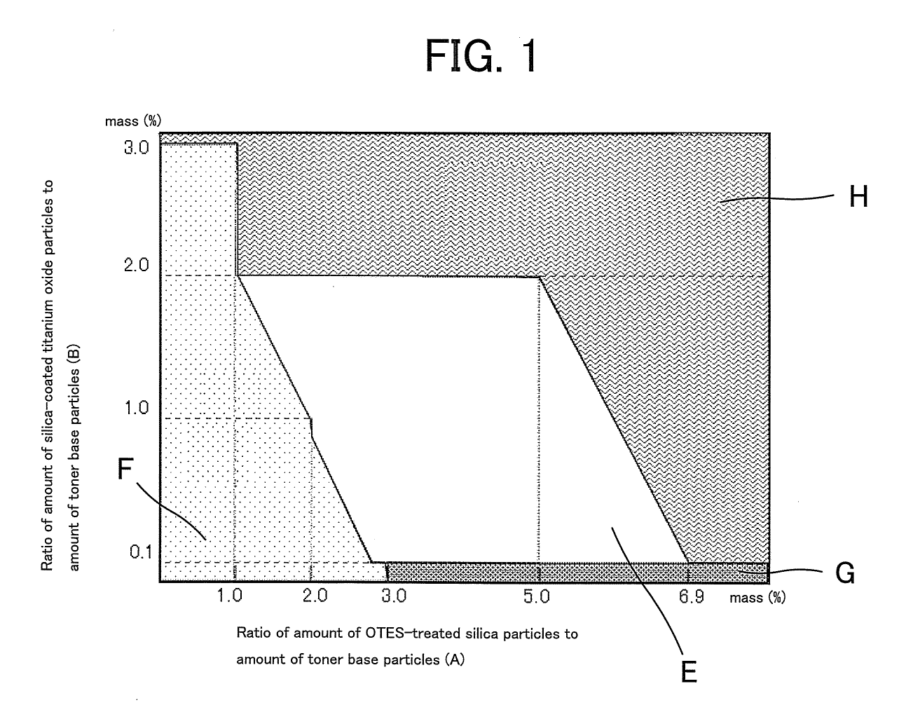

A graph is shown in FIG. 1 for facilitating the understanding of the relations among the ratio (A) of the amount of the OTES-treated silica particles to the amount of the toner base particles, the ratio (B) of the amount of the silica-coated titanium oxide particles to the amount of the toner base particles, and the ratio (C) of the amount of particles to be externally added to the toner base particles (the total amount of the external additive) to the amount of the toner base particles.

For facilitating understanding, in each toner shown as an example in FIG. 1, the external additive to be externally added to the toner base particles is composed of OTES-treated silica particles and silica-coated titanium oxide particles.

In FIG. 1, a toner categorized in a region E satisfies the relations (1) to (4) described above.

Further, a toner categorized in a region F contains the particles to be externally added to the toner base particles as the external additive in a smaller amount than a toner categorized in the region E and has lower fluidity than a toner categorized in the region E, and therefore is inferior in terms of the conveying performance.

A toner categorized in a region G contains the silica-coated titanium oxide particles in a smaller amount than a toner categorized in the region E and has a larger environmental variation in the charge amount than a toner categorized in the region E.

A toner categorized in a region H more easily causes the detachment of the external additive than a toner categorized in the region E, and is more liable to decrease a charge amount with the passing of time than a toner categorized in the region E.

The toner according to this embodiment can be produced by, for example, forming toner base particles and externally adding, as an external additive, particles including OTES-treated silica particles and silica-coated titanium oxide particles to the toner base particles.

The toner base particles according to this embodiment contain, for example, a binder resin and a coloring agent.

The coloring agent refers to a single compound or a composition that imparts a color to the toner. In this embodiment, the coloring agent is configured to contain a color developable compound and a color developing agent, whereby a decolorizable toner can be formed.

The color developable compound is an electron donating compound which accepts a proton from the color developing agent when coupling thereto. In this embodiment, the color developable compound is not particularly limited and can be appropriately selected by those skilled in the art, however, for example, a leuco dye can be used. Examples of the leuco dye include diphenylmethane phthalides, phenylindolyl phthalides, indolyl phthalides, diphenylmethane azaphthalides, phenylindolyl azaphthalides, fluorans, styrynoquinolines, and diaza-rhodamine lactones.

Specific examples thereof include 3,3-bis(p-dimethylaminophenyl)-6-dimethylaminophthalide, 3-(4-diethylaminophenyl)-3-(1-ethyl-2-methylindol-3-yl)phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrano(2,3-d)pyrimidine-5,1′(3′H)isobenzofuran]-3′-one, 2-(diethylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-methyl-, spiro[5H-(1)benzopyrano(2,3-d)pyrimidine-5,1′(3′H)isobenzofuran]-3′-one, 2-(di-n-butylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(N-ethyl-N-i-amylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. Additional examples thereof include pyridine compounds, quinazoline compounds, and bisquinazoline compounds. These compounds may be used by mixing two or more kinds thereof.

The color developing agent to be used in this embodiment is an electron accepting compound which donates a proton to the color developable compound such as a leuco dye. Examples of the color developing agent include phenols, metal salts of phenols, metal salts of carboxylic acids, aromatic carboxylic acids, aliphatic carboxylic acids having 2 to 5 carbon atoms, benzophenones, sulfonic acids, sulfonates, phosphoric acids, metal salts of phosphoric acids, acidic phosphoric acid esters, metal salts of acidic phosphoric acid esters, phosphorous acids, metal salts of phosphorous acids, monophenols, polyphenols, 1,2,3-triazole, and derivatives thereof. Additional examples thereof include those having, as a substituent, an alkyl group, an aryl group, an acyl group, an alkoxycarbonyl group, a carboxy group or an ester thereof, an amide group, a halogen group, or the like, and bisphenols, trisphenols, phenol-aldehyde condensed resins, and metal salts thereof. These compounds may be used by mixing two or more kinds thereof.

Specific examples thereof include phenol, o-cresol, tertiary butyl catechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acid or esters thereof such as 2,3-dihydroxybenzoate and methyl 3,5-dihydroxybenzoate, resorcin, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl)ethane, 1,1-bis(4-hydroxyphenyl)-3-methylbutane, 1,1-bis(4-hydroxyphenyl)-2-methylpropane, 1,1-bis(4-hydroxyphenyl)-n-hexane, 1,1-bis(4-hydroxyphenyl)-n-heptane, 1,1-bis(4-hydroxyphenyl)-n-octane, 1,1-bis(4-hydroxyphenyl)-n-nonane, 1,1-bis(4-hydroxyphenyl)-n-decane, 1,1-bis(4-hydroxyphenyl)-n-dodecane, 2,2-bis(4-hydroxyphenyl)butane, 2,2-bis(4-hydroxyphenyl)ethyl propionate, 2,2-bis(4-hydroxyphenyl)-4-methylpentane, 2,2-bis(4-hydroxyphenyl)hexafluoropropane, 2,2-bis(4-hydroxyphenyl)-n-heptane, 2,2-bis(4-hydroxyphenyl)-n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol, and methylenetris-p-cresol.

Further, as the coloring agent, a carbon black, an organic or inorganic pigment or dye, or the like may be used.

Examples of the carbon black include acetylene black, furnace black, thermal black, channel black, and Ketjen black. Examples of the pigment or dye include fast yellow G, benzidine Yellow, indofast orange, irgajin red, carmen FB, permanent bordeaux FRR, pigment orange R, lithol red 2G, lake red C, rhodamine FB, rhodamine B lake, phthalocyanine blue, pigment blue, brilliant green B, phthalocyanine green, and quinacridone. These coloring agents can be used alone or in admixture.

The binder resin constituting the toner according to this embodiment is not particularly limited and can be appropriately selected by those skilled in the art.

For example, as the binder resin, a polyester-based resin obtained by subjecting a dicarboxylic acid component and a diol component to an esterification reaction, followed by polycondensation, or a polystyrene-based resin can be used.

Examples of the dicarboxylic acid component include aromatic dicarboxylic acids such as terephthalic acid, phthalic acid, and isophthalic acid; and aliphatic carboxylic acids such as fumaric acid, maleic acid, succinic acid, adipic acid, sebacic acid, glutaric acid, pimelic acid, oxalic acid, malonic acid, citraconic acid, and itaconic acid.

Examples of the diol component include aliphatic diols such as ethylene glycol, propylene glycol, 1,4-butanediol, 1,3-butanediol, 1,5-pentanediol, 1,6-hexanediol, neopentyl glycol, trimethylene glycol, trimethylolpropane, and pentaerythritol; alicyclic diols such as 1,4-cyclohexanediol and 1,4-cyclohexanedimethanol; and ethylene oxide adducts or propylene oxide adducts of bisphenol A.

Further, the above polyester component may be converted so as to have a crosslinking structure using a trivalent or higher polyvalent carboxylic acid component or a trihydric or higher polyhydric alcohol component such as 1,2,4-benzenetricarboxylic acid (trimellitic acid) or glycerin.

In the toner according to this embodiment, two or more kinds of polyester resins having different compositions may be mixed and used.

Further, in the toner according to this embodiment, the polyester resin may be crystalline or noncrystalline.

Further, as a polystyrene-based resin, a resin obtained by copolymerization of an aromatic vinyl component and a (meth)acrylic acid ester component is preferred. Examples of the aromatic vinyl component include styrene, α-methylstyrene, o-methylstyrene, and p-chlorostyrene. Examples of the acrylic acid ester component include ethyl acrylate, propyl acrylate, butyl acrylate, 2-ethylhexyl acrylate, butyl methacrylate, ethyl methacrylate, and methyl methacrylate. Among these, butyl acrylate is generally used. As the polymerization method, an emulsion polymerization method is generally employed, and the resin is obtained by radical polymerization of monomers of the respective components in an aqueous phase containing an emulsifying agent.

Incidentally, the glass transition temperature of a polyester resin or a polystyrene-based resin can be appropriately set by those skilled in the art.

The weight average molecular weight Mw of the polyester-based resin is preferably 5000 or more and 30000 or less. On the other hand, the weight average molecular weight Mw of the polystyrene-based resin is preferably 10000 or more and 70000 or less. If the weight average molecular weight Mw of the polyester-based resin is less than 5000 (in the case of the polystyrene-based resin, less than 10000), the heat resistance and storage stability of the toner is decreased as compared with the case where the Mw is within the above range. Meanwhile, if the weight average molecular weight Mw of the polyester-based resin is more than 30000 (in the case of the polystyrene-based resin, more than 70000), the fixing temperature is increased as compared with the case where the Mw is within the above range, and therefore, the Mw more than the above range is not preferred from the viewpoint of suppressing the power consumption in a fixing treatment.

In this embodiment, the toner base particles may contain a release agent in addition to the binder resin and the coloring agent.

The release agent to be contained in the toner is not particularly limited, and examples thereof include aliphatic hydrocarbon-based waxes such as low-molecular weight polyethylenes, low-molecular weight polypropylenes, polyolefin copolymers, polyolefin waxes, microcrystalline waxes, paraffin waxes, and Fischer-Tropsch waxes; oxides of aliphatic hydrocarbon-based waxes such as polyethylene oxide waxes or block copolymers thereof, vegetable waxes such as candelilla wax, carnauba wax, Japan wax, jojoba wax, and rice wax; animal waxes such as bees wax, lanolin, and spermaceti wax; mineral waxes such as ozokerite, ceresin, and petrolactam; waxes containing, as a main component, a fatty acid ester such as montanic acid ester wax and castor wax; and materials obtained by deoxidization of a part or the whole of a fatty acid ester such as deoxidized carnauba wax. Further, saturated linear fatty acids such as palmitic acid, stearic acid, montanic acid, and long-chain alkyl carboxylic acids having a long-chain alkyl group; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, melissyl alcohol, and long-chain alkyl alcohols having a long-chain alkyl group; polyhydric alcohols such as sorbitol; fatty acid amides such as linoleic acid amide, oleic acid amide, and lauric acid amide; saturated fatty acid bisamides such as methylenebis stearic acid amide, ethylenebis caprylic acid amide, ethylenebis lauric acid amide, and hexamethylenebis stearic acid amide; unsaturated fatty acid amides such as ethylenebis oleic acid amide, hexamethylenebis oleic acid amide, N,N′-dioleyl adipic acid amide, and N,N′ -dioleyl sebacic acid amide; aromatic bisamides such as m-xylenebis stearic acid amide, and N,N′ -distearyl isophthalic acid amide; fatty acid metal salts (generally called metallic soaps) such as calcium stearate, calcium laurate, zinc stearate, and magnesium stearate; waxes obtained by grafting of a vinyl-based monomer such as styrene or acrylic acid on an aliphatic hydrocarbon-based wax; partially esterified products of a fatty acid and a polyhydric alcohol such as behenic acid monoglyceride; and methyl ester compounds having a hydroxyl group obtained by hydrogenation of a vegetable fat or oil can be exemplified.

Further, the toner base particles according to this embodiment may further contain a charge control agent. As the charge control agent, a metal-containing azo compound is used, and the metal element is preferably a complex or a complex salt of iron, cobalt, or chromium, or a mixture thereof. Further, a metal-containing salicylic acid derivative compound can also be used as the charge control agent. If the metal-containing salicylic acid derivative compound is used, the metal element thereof is preferably a complex or a complex salt of zirconium, zinc, chromium, or boron, or a mixture thereof.

Still further, if the toner base particles contain a color developable compound and a color developing agent as the coloring agent, the toner may further contain a decolorizing agent. The decolorizing agent is a substance which is preferentially compatible with the color developing agent and therefore has an action of erasing a color by reducing the interaction between the color developable compound and the color developing agent, and a known substance can be used in this embodiment. The toner according to this embodiment can be decolorized by heating even if the toner does not contain a decolorizing agent, however, by incorporating the decolorizing agent, a decolorizing treatment can be more promptly performed.

The toner according to this embodiment can be produced by externally adding the external additive containing the OTES-treated silica particles and the silica-coated titanium oxide particles to the toner base particles. A method for externally adding the external additive to the toner base particles is not particularly limited and can be appropriately selected by those skilled in the art.

Also, a method for preparing the toner base particles is not particularly limited. For example, the toner base particles may be prepared by a kneading pulverization method. The kneading pulverization method refers to a method in which, for example, a binder resin and a coloring agent, and if necessary, a release agent or the like are mixed by a dry process, the resulting mixture is melt-kneaded using an extruder or the like, and the resulting kneaded material is pulverized, followed by classification, thereby obtaining toner base particles.

Further, the toner base particles may be prepared by a chemical production method such as a suspension polymerization method, an emulsion aggregation method, or a dissolution suspension method.

In addition, the toner base particles may be prepared by mixing a particulate mixture containing a binder resin and a coloring agent with an aqueous medium, thereby forming a dispersion liquid of the mixture, applying a mechanical shearing force to the obtained dispersion liquid of the mixture, thereby finely pulverizing the mixture in the dispersion liquid, and aggregating and fusing the finely pulverized mixture.

Specifically, for example, the preparation can be performed as follows.

First, the constituent components (toner material) including the binder resin and the coloring agent are kneaded using a twin-screw kneader or the like, and the resulting kneaded material is pulverized, whereby a coarsely pulverized mixture in the form of particles is obtained.

To this coarsely pulverized mixture, an aqueous medium containing water or an organic solvent or the like miscible with water is added, whereby a dispersion liquid of the mixture (a toner material dispersion liquid) is prepared. The aqueous medium may contain at least either of a surfactant and a basic compound.

The surfactant is not particularly limited, however, examples thereof include anionic surfactants such as sulfate ester salt-based, sulfonate-based, phosphate ester-based, and soap-based surfactants; cationic surfactants such as amine salt-based and quaternary ammonium salt-based surfactants; and nonionic surfactants such as polyethylene glycol-based, alkylphenol ethylene oxide adduct-based, and polyhydric alcohol-based surfactants.

Examples of the basic compound include amine compounds, and for example, dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, N,N-diethyl-1,3-diaminopropane, or the like can be used. The basic compound functions as, for example, a dispersing aid.

A mechanical shearing force is applied to this toner material dispersion liquid to effect fine pulverization. The fine pulverization refers to a process in which the particle diameter of the particulate mixture in the dispersion liquid is made smaller than before applying the shearing force.

Examples of a mechanical shearing apparatus which can be used for applying a mechanical shearing force include mechanical shearing apparatuses which do not use media such as Ultra Turrax (manufactured by IKA Japan K.K.), T.K. Auto Homo Mixer (manufactured by Primix Corporation), T.K. Pipeline Homo Mixer (manufactured by Primix Corporation), T.K. Filmics (manufactured by Primix Corporation), Clear mix (manufactured by M-Technique Co., Ltd.), Clear SSS (manufactured by M-Technique Co., Ltd.), Cavitron (manufactured by Eurotec, Ltd.), Fine Flow Mill (manufactured by Pacific Machinery & Engineering Co., Ltd.), Microfluidizer (manufactured by Mizuho Industrial Co., Ltd.), Altimizer (manufactured by Sugino Machine, Ltd.), Nanomizer (manufactured by Yoshida Kogyo Co., Ltd.), Genus PY (manufactured by Hakusui Chemical Industries Co., Ltd.), and NANO 3000 (manufactured by Beryu Co., Ltd.); and mechanical shearing apparatuses which use media such as Visco mill (manufactured by Aimex Co., Ltd.), Apex mill (manufactured by Kotobuki Industries Co., Ltd.), Star Mill (manufactured by Ashizawa Finetech, Ltd.), DCP Super flow (manufactured by Nippon Eirich Co., Ltd.), MP Mill (manufactured by Inoue Manufacturing Co., Ltd.), Spike Mill (manufactured by Inoue Manufacturing Co., Ltd.), Mighty Mill (manufactured by Inoue Manufacturing Co., Ltd.), and SC Mill (manufactured by Mitsui Mining Co., Ltd.).

Subsequently, the toner material dispersion liquid in which the mixture was finely pulverized is subjected to an aggregation step and a fusion step. Specifically, an aggregating agent is added to the toner material dispersion liquid, followed by heating, whereby the particulate mixture is aggregated. The kind of the aggregating agent, the addition amount thereof, and the heating temperature can be appropriately set by those skilled in the art.

Examples of the aggregating agent include metal salts such as sodium chloride, calcium chloride, calcium nitrate, barium chloride, magnesium chloride, zinc chloride, magnesium sulfate, aluminum chloride, aluminum sulfate, and potassium aluminum sulfate; inorganic metal salt polymers such as polyaluminum chloride, polyaluminum hydroxide, and calcium polysulfide; polymeric aggregating agents such as polymethacrylic acid esters, polyacrylic acid esters, polyacrylamides, and acrylamide-sodium acrylate copolymers; coagulating agents such as polyamines, polydiallyl ammonium halides, melanin formaldehyde condensates, and dicyandiamide; alcohols such as methanol, ethanol, 1-propanol, 2-propanol, 2-methyl-2-propanol, 2-methoxyethanol, 2-ethoxyethanol, and 2-butoxyethanol; organic solvents such as acetonitrile and 1,4-dioxane; inorganic acids such as hydrochloric acid and nitric acid; and organic acids such as formic acid and acetic acid.

Subsequently, the fluidity of the binder resin is increased by heating, and the aggregated binder resin, coloring agent, and release agent are fused. The heating temperature in the fusing treatment can also be appropriately set by those skilled in the art.

Subsequently, the particles obtained by the fusing treatment are washed and dried, whereby the toner base particles are prepared.

The toner according to this embodiment can be used in the formation of an image on an electrophotographic recording medium by being placed in an image forming apparatus such as an MFP (multifunction peripheral) as, for example, a non-magnetic one-component developer or two-component developer. If the toner is used in a two-component developer, a carrier which can be used is not particularly limited and can be appropriately selected by those skilled in the art.

In an image formation step, a toner image formed with the toner according to this embodiment transferred onto a recording medium is heated at a fixing temperature, and therefore a resin is melted to penetrate in the recording medium, and thereafter the resin is solidified, whereby an image is formed on the recording medium (fixing treatment).

Further, if the toner contains a coloring agent containing a color developable compound and a color developing agent, an image formed on a recording medium can be erased by performing a decolorizing treatment of the toner. Specifically, the decolorizing treatment can be performed as follows. The recording medium having an image formed thereon is heated at a heating temperature not lower than the decolorizing initiation temperature, thereby decoupling the coupled color developable compound and color developing agent from each other.

### EXAMPLES

Hereinafter, the toner according to this embodiment will be described with reference to examples. However, the invention is by no means limited to the following Examples.

### [Preparation of Toner Base Particles 1]

90 parts by mass of a polyester resin, 5 parts by mass of a cyan pigment (copper phthalocyanine) as a coloring agent, 4 parts by mass of an ester wax, and 1 part by mass of a zirconia metal complex as a charge control agent were mixed, and the resulting mixture was melt-kneaded using a twin-screw kneader which was set to a temperature of 120° C., whereby a kneaded material was obtained.

The thus obtained kneaded material was coarsely pulverized using a feather mill and then pulverized using a jet mill. Then, the pulverized material was classified using a rotor classifier, whereby toner base particles 1 having a volume average particle diameter of 5.8 μm were obtained.

### [Preparation of Toner Base Particles 2]

90 parts by mass of a polyester resin, 5 parts by mass of a cyan pigment (copper phthalocyanine) as a coloring agent, 4 parts by mass of an ester wax, and 1 part by mass of a zirconia metal complex as a charge control agent were mixed, and the resulting mixture was melt-kneaded using a twin-screw kneader which was set to a temperature of 120° C., whereby a kneaded material was obtained.

The thus obtained kneaded material was coarsely pulverized to a volume average particle diameter of 1.2 mm using a hammer mill manufactured by Nara Machinery Co., Ltd., and the resulting coarse particles were put into a bantam mill manufactured by Hosokawa Micron Corporation which was set to a rotational speed of 12000 rpm, whereby moderately pulverized particles were obtained.

40 parts by mass of the moderately pulverized particles, 2 parts by mass of sodium dodecylbenzene sulfonate as a dispersing agent, 2 parts by mass of a sodium salt of a copolymer of acrylic acid and maleic acid, 2 parts by mass of triethylamine as a dispersing aid, and 65 parts by mass of ion exchanged water were preliminarily dispersed using ULTRA TURRAX T50 manufactured by IKA Japan K.K., whereby a preliminary dispersion liquid was obtained.

The thus obtained preliminary dispersion liquid was put into a Nanomizer (manufactured by Yoshida Kikai Co. Ltd., YSNM-2000AR additionally having a heating system). The temperature of the heating system was set to 160° C. and the processing pressure of the Nanomizer was set to 160 MPa, and the dispersion liquid was processed. The processing operation was repeated three times.

While maintaining the dispersion liquid processed by the Nanomizer at 40° C., 2 parts by mass of aluminum sulfate was added thereto, and the temperature of the mixture was raised to 55° C. to aggregate the material of the toner base particles to a desired volume average particle diameter, whereby an aggregated particle dispersion liquid was obtained. Thereafter, 4 parts by mass of a sodium salt of a copolymer of acrylic acid and maleic acid was added thereto as a dispersion stabilizing agent. Then, the temperature of the mixture was raised to 90° C. and the mixture was left as such for 3 hours, whereby a fused particle dispersion liquid was obtained.

After the thus obtained fused particle dispersion liquid was subjected to solid-liquid separation, 600 ml of ion exchanged water was added as a washing solution and washing was performed. The resulting solid component was dried using a vacuum dryer, whereby toner base particles 2 having a volume average particle diameter of 4.8 μm were obtained.

### [Preparation of Toner Base Particles 3]

90 parts by mass of a polyester resin, 5 parts by mass of a cyan pigment (copper phthalocyanine) as a coloring agent, 4 parts by mass of an ester wax, and 1 part by mass of a zirconia metal complex as a charge control agent were mixed, and the resulting mixture was melt-kneaded using a twin-screw kneader which was set to a temperature of 120° C., whereby a kneaded material was obtained.

The thus obtained kneaded material was coarsely pulverized using a feather mill and then pulverized using a jet mill. Then, the pulverized material was classified using a rotor classifier, whereby toner base particles 3 having a volume average particle diameter of 6.8 μm were obtained.

### Example 1

To the toner base particles 1, OTES-treated silica particles (TGC-443, manufactured by Cabot Corporation) at 3.4% by mass, silica particles treated with hexamethyldisilazane (HMDS) (NAX-50, manufactured by Aerosil Co., Ltd.) at 1.3% by mass, silica-coated titanium oxide particles (STX-801, manufactured by Aerosil Co., Ltd.) at 0.5% by mass, and titanium oxide particles surface-treated with an alkylsilane (RS) (NKT-90, manufactured by Aerosil Co., Ltd.) at 0.7% by mass were added, and an external addition treatment was performed using a Henschel Mixer. Then, the resulting particles were passed through an ultrasonic vibration sieve, whereby a toner of Example 1 was obtained.

Incidentally, the ratio of each external additive is expressed as a percentage by mass based on the amount of the toner base particles.

The thus obtained toner of Example 1 was evaluated for the properties according to methods described below.

### (I) Measurement Method for Si Intensity Change by Impact Treatment

A change in Si intensity measured using an X-ray fluorescence analyzer when an ultrasonic impact treatment was applied was measured.

### [Dispersion Step]

In a 100 ml beaker, 11 parts by mass of the toner of Example 1, 56.8 parts by mass of ion exchanged water, and 12.8 parts by mass of a surfactant were added and mixed, and the resulting mixture was stirred using a magnetic stirrer until the toner layer on the surface of the liquid disappeared.

### [Impact Step]

An ultrasonic wave was applied to the dispersion liquid for 10 minutes using an ultrasonic washing machine (ASONE US-1R).

### [Separation Step]

In this separation step, the external additive detached from the toner base particles in the impact step was separated from the toner base particles.

(i) After the impact step, the dispersion liquid was put into two centrifuge tubes, and ion exchanged water was added to each centrifuge tube to adjust the final volume to 45 ml.

(ii) The centrifuge tubes were centrifuged at 1000 rpm for 15 minutes using a centrifugal separator (HSIANGTAI CN-2060)

(iii) The supernatant in each of the centrifuge tubes after the centrifugation described in (ii) was removed by decantation, and ion exchanged water was added to each centrifuge tube to give a final volume of 45 ml and stirring was performed again.

(iv) The operations of (ii) and (iii) were performed two more times.

### [Washing Step]

To the toner from which the detached external additive was separated, 100 ml of ion exchanged water was added, and filtration was performed. In this step, ADVANTEC GC90 was used as a filter paper.

### [Drying Step]

The toner remaining on the filter paper after the filtration in the washing step was dried under vacuum for 8 hours or more.

### [Molding Step]

5 g of each of the toner which was not subjected to the impact treatment and the toner obtained in the above drying step was weighed and molded into a pellet using a molding machine. Incidentally, for facilitating understanding, the toner subjected to the treatment including the steps shown from the dispersion step to the drying step is referred to as a toner subjected to the impact treatment in the following description.

### [Measurement Step]

A Si intensity was measured using an X-ray fluorescence analyzer (Shimadzu Corporation, XRF-1800) for each pellet prepared in the above molding step.

A value of change in Si intensity by the impact treatment (value of Si intensity change) K [kcps] was calculated from the following formula.

K=K0−K1

In the formula, K0 represents a value [kcps] of Si intensity of a toner not subjected to the impact treatment; and K1 represents a value [kcps] of Si intensity of the toner subjected to the impact treatment.

The value K of Si intensity change of the toner of Example 1 was 9.7 kcps.

Incidentally, if the Si intensity change K by the impact treatment is 20 kcps or more, the external additive is easily detached, and therefore, the charge amount is liable to decrease with the passing of time.

### (II) Measurement of Environmental Variation in Charge Amount

The electrophotographic toner of Example 1 and a carrier (a ferrite carrier coated with a silicone resin) were divided into two groups, respectively, and one group was left for 8 hours or more under a low-temperature and low-humidity environment (10° C., 20%, hereinafter also referred to as LL environment), and the other group was left for 8 hours or more under a high-temperature and high-humidity environment (30° C., 85%, hereinafter also referred to as HH environment).

Thereafter, 5 parts by mass of the electrophotographic toner of Example 1 and 95 parts by mass of the carrier, both of which were left under the same environment, were mixed in a polyethylene container and stirred for 30 minutes using a turbula shaker mixer, whereby a two-component developer was prepared.

For the thus obtained developer, a charge amount was measured using a suction blow-off device (TB-203, manufactured by Kyocera Chemical Corporation). The charge amount of the developer containing the toner of Example 1 left under the low-temperature and low-humidity environment was −36.0 [μC/g]. Meanwhile, the charge amount of the developer containing the toner of Example 1 left under the high-temperature and high-humidity environment was −27.6 [μC/g]. Then, an environmental variation ratio was calculated from the following formula as an index for the environmental stability of a charge amount and found to be 0.77. If the environmental variation ratio is 0.60 or less, the developing property under the LL environment or the toner scattering under the HH environment is significantly deteriorated.

EC=q/m [H/H]/q/m [L/L]

In the formula, EC represents an environmental variation ratio, q/m [H/H] represents a charge amount [μC/g] of a developer containing a toner left under the high-temperature and high-humidity environment, and q/m [L/L] represents a charge amount [μC/g] of a developer containing a toner left under the low-temperature and low-humidity environment.

### (III) Evaluation Using Actual Apparatus

The toner of Example 1 was put into an MFP manufactured by Toshiba Tec Corporation e-STUDIO 4520, and a paper feed test was performed by feeding 10,000 sheets of paper through the MFP. As a carrier, a ferrite carrier coated with a silicone resin was used. subsequently, a charge amount of the developer when the developer was started to be used and a charge amount thereof after 10,000 sheets of paper was fed through the MFP were measured using a suction blow-off device (TB-203, manufactured by Kyocera Chemical Corporation), and a value of the charge amount decreased by feeding of 10,000 sheets of paper (a value of decrease in the charge amount during life) was calculated from the following formula.

q/m [D]=q/m [AJ]−q/m [END]

In the formula, q/m [D] represents a value [−μC/g] of decrease in the charge amount during life, q/m [AJ] represents a charge amount [μC/g] when the developer was started to be used, and q/m [END] represents a charge amount [μC/g] after 10,000 sheets of paper was fed through the MFP.

In addition, the level of toner scattering in the machine and the conveying performance in a toner conveying path were visually confirmed after 10,000 sheets of paper was fed through the MFP.

The evaluation criteria for the level of toner scattering are as follows.

G: The level is good

P: There seems to be no noticeable difference although the level of toner scattering is somewhat deteriorated as compared with the above case evaluated as G.

N: The toner scatters more noticeably as compared with the above case evaluated as G.

The evaluation criteria for the conveying performance in a toner conveying path are as follows.

G: There is no problem.

P: The toner adheres much to the conveying path, but the toner is conveyed.

N: The clogging of the conveying path occurs during use.

In the case of the toner of Example 1, the q/m [AJ] was −38.2 [μC/g], the q/m [END] was −35. [symbol] [μC/g], and a value of decrease in the charge amount during life was 2.5 [μC/g]. Further, the level of toner scattering was evaluated as G, and the conveying performance was evaluated as G.

### Example 2

A toner of Example 2 was obtained in the same manner as in Example 1 except that the toner base particles 1 were changed to the toner base particles 2.

### Example 3

To the toner base particles 1, OTES-treated silica particles (TGC-443, manufactured by Cabot Corporation) at 2.0% by mass, silica particles treated with dimethyldichlorosilane (DDS) (R-974, manufactured by Aerosil Co., Ltd.) at 1.0% by mass, and silica-coated titanium oxide particles (STX-801, manufactured by Aerosil Co., Ltd.) at 0.1% by mass were added, and an external addition treatment was performed using a Henschel Mixer. Then, the resulting particles were passed through an ultrasonic vibration sieve, whereby a toner of Example 3 was obtained.

### Example 4

To the toner base particles 1, OTES-treated silica particles (TGC-443, manufactured by Cabot Corporation) at 6.9% by mass and silica-coated titanium oxide particles (STX-801, manufactured by Aerosil Co., Ltd.) at 0.1% by mass were added, and an external addition treatment was performed using a Henschel Mixer. Then, the resulting particles were passed through an ultrasonic vibration sieve, whereby a toner of Example 4 was obtained.

### Example 5

To the toner base particles 2, OTES-treated silica particles (TGC-443, manufactured by Cabot Corporation) at 2.0% by mass and silica-coated titanium oxide particles (STX-801, manufactured by Aerosil Co., Ltd.) at 2.0% by mass were added, and an external addition treatment was performed using a Henschel Mixer. Then, the resulting particles were passed through an ultrasonic vibration sieve, whereby a toner of Example 5 was obtained.

### Example 6

To the toner base particles 2, OTES-treated silica particles (TGC-443, manufactured by Cabot Corporation) at 3.0% by mass, silica particles treated with dimethyldichlorosilane (DDS) (R-9200, manufactured by Aerosil Co., Ltd.) at 1.0% by mass, silica particles treated with polydimethylsiloxane (PDMS) (TG-308F, manufactured by Cabot Corporation) at 1.0% by mass, and silica-coated titanium oxide particles (STX-501, manufactured by Aerosil Co., Ltd.) at 2.0% by mass were added, and an external addition treatment was performed using a Henschel Mixer. Then, the resulting particles were passed through an ultrasonic vibration sieve, whereby a toner of Example 6 was obtained.

### Example 7

To the toner base particles 2, OTES-treated silica particles (TGC-443, manufactured by Cabot Corporation) at 1.0% by mass, silica particles treated with hexamethyldisilazane (HMDS) (R-974, manufactured by Aerosil Co., Ltd.) at 2.5% by mass, silica-coated titanium oxide particles (STX-501, manufactured by Aerosil Co., Ltd.) at 0.5% by mass, and titanium oxide particles treated with an alkylsilane (RS) (NKT-90, manufactured by Aerosil Co., Ltd.) at 1.9% by mass were added, and an external addition treatment was performed using a Henschel Mixer. Then, the resulting particles were passed through an ultrasonic vibration sieve, whereby a toner of Example 7 was obtained.

### Example 8

A toner of Example 8 was obtained in the same manner as in Example 1 except that the toner base particles 1 were changed to the toner base particles 3.

### Comparative Example 1

To the toner base particles 1, OTES-treated silica particles (TGC-443, manufactured by Cabot Corporation) at 3.4% by mass, silica particles treated with hexamethyldisilazane (HMDS) (R-812S, manufactured by Aerosil Co., Ltd.) at 1.0% by mass, silica particles treated with polydimethylsiloxane (PDMS) (NY-50, manufactured by Aerosil Co., Ltd.) at 1.5% by mass, silica-coated titanium oxide particles (STX-801, manufactured by Aerosil Co., Ltd.) at 0.5% by mass, and titanium oxide particles treated with an alkylsilane (RS) (NKT-90, manufactured by Aerosil Co., Ltd.) at 0.7% by mass were added, and an external addition treatment was performed using a Henschel Mixer. Then, the resulting particles were passed through an ultrasonic vibration sieve, whereby a toner of Comparative Example 1 was obtained.

### Comparative Example 2

To the toner base particles 1, OTES-treated silica particles (TGC-443, manufactured by Cabot Corporation) at 2.0% by mass, silica particles treated with hexamethyldisilazane (HMDS) (R-8200, manufactured by Aerosil Co., Ltd.) at 0.8% by mass, and silica-coated titanium oxide particles (STX-801, manufactured by Aerosil Co., Ltd.) at 0.1% by mass were added, and an external addition treatment was performed using a Henschel Mixer. Then, the resulting particles were passed through an ultrasonic vibration sieve, whereby a toner of Comparative Example 2 was obtained.

### Comparative Example 3

To the toner base particles 1, silica particles treated with hexamethyldisilazane (HMDS) (R-8200, manufactured by Aerosil Co., Ltd.) at 4.0% by mass and titanium oxide particles treated with an alkylsilane (RS) (NKT-90, manufactured by Aerosil Co., Ltd.) at 2.0% by mass were added, and an external addition treatment was performed using a Henschel Mixer. Then, the resulting particles were passed through an ultrasonic vibration sieve, whereby a toner of Comparative Example 3 was obtained.

### Comparative Example 4

To the toner base particles 2, silica particles treated with dimethyldichlorosilane (DDS) (R-974, manufactured by Aerosil Co., Ltd.) at 4.0% by mass and titanium oxide particles treated with an alkylsilane (RS) (NKT-90, manufactured by Aerosil Co., Ltd.) at 2.0% by mass were added, and an external addition treatment was performed using a Henschel Mixer. Then, the resulting particles were passed through an ultrasonic vibration sieve, whereby a toner of Comparative Example 4 was obtained.

### Comparative Example 5

To the toner base particles 2, silica particles treated with polydimethylsiloxane (PDMS) (NY-50, manufactured by Aerosil Co., Ltd.) at 4.0% by mass and titanium oxide particles treated with an alkylsilane (RS) (NKT-90, manufactured by Aerosil Co., Ltd.) at 2.0% by mass were added, and an external addition treatment was performed using a Henschel Mixer. Then, the resulting particles were passed through an ultrasonic vibration sieve, whereby a toner of Comparative Example 5 was obtained.

### Comparative Example 6

To the toner base particles 2, OTES-treated silica particles (TGC-443, manufactured by Cabot Corporation) at 4.0% by mass, silica particles treated with dimethyldichlorosilane (DDS) (R-974, manufactured by Aerosil Co., Ltd.) at 0.5% by mass, and silica-coated titanium oxide particles (STX-501, manufactured by Aerosil Co., Ltd.) at 2.2% by mass were added, and an external addition treatment was performed using a Henschel Mixer. Then, the resulting particles were passed through an ultrasonic vibration sieve, whereby a toner of Comparative Example 6 was obtained.

### Comparative Example 7

To the toner base particles 2, OTES-treated silica particles (TGC-443, manufactured by Cabot Corporation) were added at 3.1% by mass, and an external addition treatment was performed using a Henschel Mixer. Then, the resulting particles were passed through an ultrasonic vibration sieve, whereby a toner of Comparative Example 7 was obtained.

### Comparative Example 8

To the toner base particles 2, OTES-treated silica particles (TGC-443, manufactured by Cabot Corporation) at 0.8% by mass, silica particles treated with hexamethyldisilazane (HMDS) (R-8200, manufactured by Aerosil Co., Ltd.) at 2.5% by mass, silica-coated titanium oxide particles (STX-501, manufactured byAerosil Co., Ltd.) at 0.5% by mass, and titanium oxide particles treated with an alkylsilane (RS) (NKT-90, manufactured by Aerosil Co., Ltd.) at 1.9% by mass were added, and an external addition treatment was performed using a Henschel Mixer. Then, the resulting particles were passed through an ultrasonic vibration sieve, whereby a toner of Comparative Example 8 was obtained.

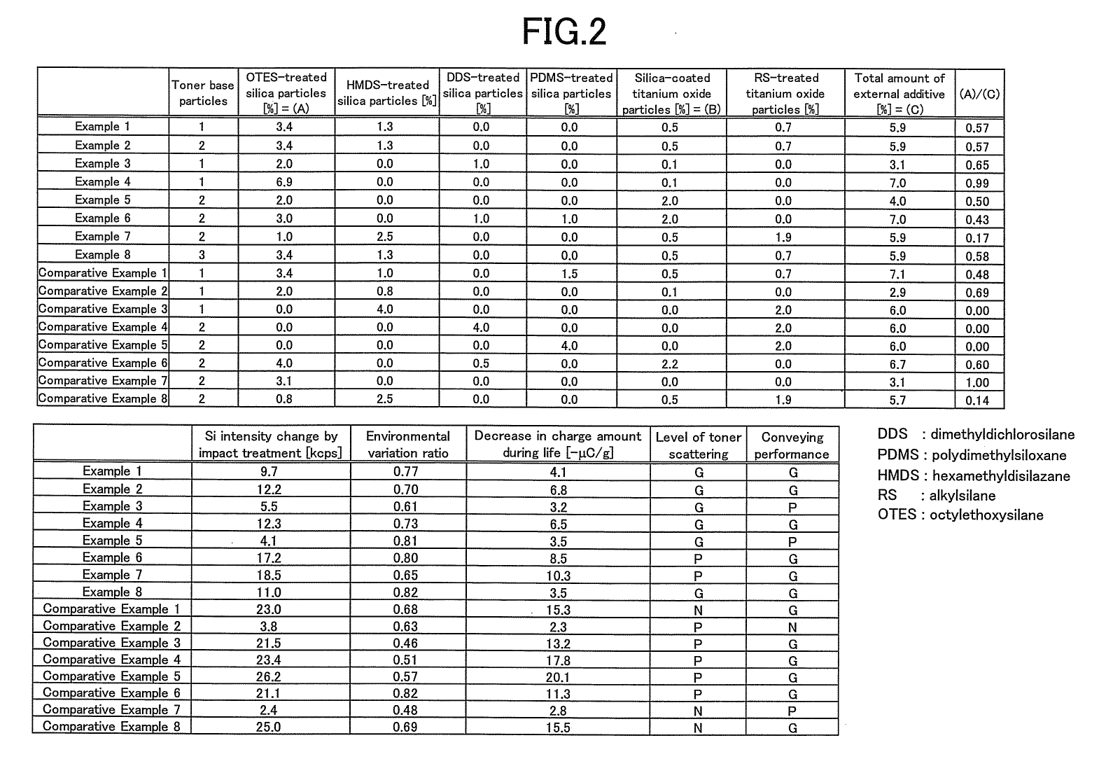

The toners of Examples 2 to 8 and Comparative Examples 1 to 8 were also evaluated in the same manner as the toner of Example 1. The results are shown in FIG. 2.

As understood from FIG. 2, in the case of the toners of Examples 1 to 8, which satisfy the relations (1) to (4) with respect to (A), (B), and (C), a decrease in the charge amount with the passing of time and an environmental variation ratio of the charge amount are largely improved as compared with the case of the toners of Comparative Examples 1 to 8. In particular, in the case of the toners of Examples 1 to 5 and 8, which satisfy the relation: 0.5≦(A)/(C)<1, a decrease in the charge amount with the passing of time can be further suppressed.

While certain embodiments have been described, these embodiments have been presented by way of example only, and are not intended to limit the scope of invention. Indeed, the novel toner described herein may be embodied in a variety of other forms; furthermore, various omissions, substitutions and changes in the form of the toner described herein may be made without departing from the spirit of the inventions. The accompanying claims and their equivalents are intended to cover such forms or modifications as would fall within the scope and spirit of the inventions.

As described in detail above, according to the technique described in this specification, a toner which can suppress a decrease in the charge amount with the passing of time and a change in the charge amount due to an environmental variation can be provided.

What is claimed is:

1. An electrophotographic toner, comprising:
toner base particles having a volume average particle diameter of 3 μm or more and 7 μm or less;
OTES-treated silica particles which are silica particles treated with octyltriethoxysilane (OTES) and are externally added to the toner base particles; and
silica-coated titanium oxide particles which are titanium oxide particles coated with silica and are externally added to the toner base particles along with the OTES-treated silica particles, wherein
the ratio (A) of the amount of the OTES-treated silica particles to the amount of the toner base particles, the ratio (B) of the amount of the silica-coated titanium oxide particles to the amount of the toner base particles, and the ratio (C) of the amount of particles to be externally added to the toner base particles to the amount of the toner base particles satisfy the following relations:
1% by mass≦(A)≦6.9% by mass;
0.1% by mass≦(B)≦2% by mass;
3% by mass≦(C)≦7% by mass; and
0.15≦(A)/(C)<1.

2. The toner according to claim 1, which satisfies the following relation: 0.5≦(A)/(C)<1.

3. The toner according to claim 1, wherein the toner base particles are prepared by:
mixing a particulate mixture containing a binder resin and a coloring agent with an aqueous medium, thereby forming a dispersion liquid of the mixture;
applying a mechanical shearing force to the dispersion liquid of the mixture, thereby finely pulverizing the mixture in the dispersion liquid; and
aggregating and fusing the finely pulverized mixture.

4. The toner according to claim 1, wherein the toner base particles contain a coloring agent containing a color developable compound and a color developing agent and therefore can be decolorized.
